(19) United States
(12) Patent Application Publication
(10) Pub. No.: US 2011/0248868 A1
(43) Pub. Date: Oct. 13, 2011

(54) Traffic density based safety shutoff mechanism for compression or converging traffic management system

(76) Inventor: James Jacob Free, Elkhart, IN (US)

(21) Appl. No.: 12/798,613

(22) Filed: Apr. 8, 2010

(51) Int. Cl. G08G 1/095

(52) U.S. Cl. 340/907

(57) ABSTRACT

During any kind of traffic management involving consolidation or compression, or converging readouts or outputs, shortening of individual vehicle headway, there is a necessity that vehicles in a moving pattern must get closer together. For the particular case of taking random traffic approaching a traffic signal and consolidating traffic to go through the signal during the green phase, vehicles must be substantially consolidated at a ratio of the service cycle of the traffic signal to the “net” green during which time they all pass through the signal. This remains true for both autonomic as well as adjustable adaptable phase-changing traffic management systems. Traffic density (passing vehicle number per time) is measured before or at the beginning of traffic management. Density figures are compared under a predetermined scheduling/convergence mechanism that takes into account the densest traffic will be, or the closest vehicles will be with respect to one another. If the pre-compressed, pre-converging density is found to be lean or sparse enough for traffic management to function, outputs are allowed to continue and traffic management is allowed to remain open. If the pre-compressed, pre-converging density is found to be too dense, that is, if the densest place or duration in traffic management is too close for a safe headway or reaction time, than traffic management/outputs are suspended.

### STATEMENT REGARDING FEDERALLY FUNDED RESEARCH AND DEVELOPMENT

Not Applicable
U.S. Pat. No. 3,302,168 Gray January 1967 340/932
Free Ser. No. 61/197,343 Oct. 27, 2008
Free Ser. No. 61/197,396 Oct. 27, 2008
Free Ser. No. 61/197,364 Oct. 27, 2008
Free, James Paper Published at Intelligent Transportation Society of America Jun. 3^{rd}, 2009

### FIELD

This invention relates to the sensing of traffic density before, and in the early stages of traffic management, and processing whether vehicles would get too close to one another any time during that management, consolidation, shrinking headways or compression. More specifically, the processing would assure that headways, following distances or reaction times don't get too close, especially after traffic has been compressed or condensed.

### BACKGROUND OF THE INVENTION

Gray, 1967 employs detectors as well as speed governing traffic management systems and addresses the issue of driving in conditions of lower visibility such as fog. There is no mention of a simple suspension of traffic management if the conditions are to be found as non safe, for example if headway, safe following distances were too close or the reaction time were too short. Traffic would be unsafe if following distances were too close.

### CROSS REFERENCE TO RELATED APPLICATIONS

The inventions of FREE, (Ser. No. 12/589,793; Oct. 27, 2009, Ser. No. 12/589,792; Oct. 27, 2009, Ser. No. 12/657,256; Jan. 15, 2010) describe emplaced, mobile, sensory-adaptive readout versions respectively of systems that tell motorists how fast they should go in order to make it through a traffic signal while that signal is in the green phase. They use the acronym FLOW standing for “Fast Lane On Warning”, centering around the concepts of the basic necessary parameters:
1. of the fact that the speed limit should not be succeeded,
2. that no assignments or readouts should cross-assign,
3. and further, that the same general proportion of vehicles arriving before consolidation or compression should remain in that general proportion of where they were in the hierarchy of a random string of traffic before compression started.

In the Emplaced and Mobile versions of Free (2009), the readouts are somewhat autonomous. In “Robotic” or sensory based adaptive version of Free (2010) readouts are sensor based and adaptive where the hierarchical proportion may change. There, in relation to the third parameter above, the traffic could get shifted around in order to spread out the pattern or FLOW distribution, maximize following distances, optimize the mobility and green time for passing net-compressed traffic management patterns/FLOW patterns and the like.

Generally speaking, traffic approaches the traffic management area as a random string or pattern 25 (in [FIG. 2, 3]) of length Pi, the traffic signal service cycle. In traffic management, it is compressed or consolidated with converging speed assignments 21. Next, it goes through the green phase wile still moving 24 (thus saving lots of energy), then is allowed to diverge or spread out again after traffic management 26.

Also, the option of a “net” green 13 in [FIG. 2] that is part of a larger whole green phase 15 that would allow for safety time buffers either before 16, after 17, or both around a “net” green physical length FLOW pattern as well as time period 13. The green phase 15 would also come with a red phase 19 and yellow phase 18 (in [FIG. 2]) at the place where traffic management would see vehicles the closest they would be 24 (in [FIG. 3]).

In the references of Free (2009), converging compression speed assignments 21 (in [FIG. 3]) are dictated by the function:

$$Vsa = \frac{X}{( Pi - Pa ) + Pi + pgS - [ 1 - \frac{( Pi - Pa )}{Pi} ] Tng}$$

Where:

Vsa is output of speed assignment,
X is position or distance to the traffic signal,
pgS is a safety buffer time period 13 (in [FIG. 2]) where earlier arrivals can be accounted for that also results in a safety “extra” following distance,
Pa is arrival point in time where “X” 22 in [FIG. 3] is taken,
Pi is service cycle of the traffic signal, Pi>Pa>0,
Pi and Pa are an arrival function that counts down every repetition of the service cycle. There can also be a safety following buffer initiated by further shrinking Tng so that a Psf; safety following time buffer can be Psf=G−Tng−pgS. The same Pi applies to that random incoming pattern 23 as well as the mature post compressed, “net” or “fully” compressed pattern 20.

For the sensory based adaptable, the Vsa function above includes the extra “adaptivity” expression

$$\pm \frac{{d}^{2} X}{d {t}^{2}} .$$

The main function works for:
1. An emplaced readout along side the road (roadside unit; RSU) approaching the traffic signal as well as,
2. A wireless mobile readout that is onboard the vehicle.
3. And as well, an adaptive changing system of readouts that can adjust Pi, Tng for single and multiple directions (i.e. including cross traffic), depending on sensory based conditions.

For the emplaced, there would be one or a multiple of readouts that send out changeable speed assignments that tell motorists what speed to go in order to make it through the signal 2 (in [FIG. 1]) during the green phases. This set of FLOW readouts 8 would repeat itself just as the phases of the signal do. For the mobile, there would be a receiver calculator aboard the vehicle that receives signals form a sequencer 6 (in [FIG. 1]) working in concert with the traffic signal RGY sequencer 7 telling Status or “Signal Phase And Timing” information (SPAT), as well as signals of where it is located with respect to the traffic signal. With this status and location data being downloaded or stowed, the receiver calculator on board the approaching vehicle would do “scans” of the calculation and output the readouts of how fast the vehicle should go. For adaptable systems, the Tng could be expanded or shrunk in a single lane that is absorbing stragglers, absorbing stopped waiting traffic and/or so on. Also, Tng could be shrunk for opposing direction traffic or cross traffic. As one direction is detected to be sparse while the opposing direction is detected to be dense, the Tng could be expanded and proportionally contracted to allow for more traffic per green in both directions. If conditions were to become adverse, Pi for both directions could be expanded and as well, the speed assignments could be slowed down also allowing for more traffic per green despite adverse conditions.

This relation would work for a situation where there was a somewhat distinct node, or actual threshold point, as well as a looser interpretation of a node where that point is more of a zone or range. The point node would be along an approach or run up to the traffic signal and would serve as a threshold where compression began. The node would be where there would be a complete set of readouts or speed assignments throughout the repeating Pi. Any closer, and there would begin to be opening up a “blind spot” or “void” or place and time where FLOW readouts would not be present. To make up for this blind spot, specially tailored readouts all throughout the period of the repeating Pi could include mathematical enhancements or programmed inputs or the like to bring the traffic (that could have turned onto the FLOW lane, straggled, or the like) into the appropriate, most likely following FLOW pattern.

For the looser node interpretation, there could be a range of where compression begins as opposed to a specific point in the run up. And instead of a set of readouts that go through the range of Pi at a certain place, the place, “X” 22 (in [FIG. 3]), a new scan with new X could be taken each time the scan was done or each time the calculation is run through.

For safety purposes, each of these inventions would need to operate under a safety threshold where it is either OK to operate safely or where traffic at its closest in management, i.e. where the vehicles' headway was as close at it would get under maximum compression, would be too close for adequate reaction time.

There should be the necessity of safety in these inventions that would be where there could be no traffic managing if the closest following distance, headway, following “space time”, reaction time, relative distance or the like would be closer than a pre set safe convention of what that headway, reaction time would be.

### OBJECT OF THE INVENTION

It is therefore an object of this invention to provide for a safety shutoff where traffic management system would be made to shut down for unsafe conditions such as fog (or other like bad conditions), but especially if headways, following distances were too close, or reaction times were too short.

It is also an object to provide for a safety shutoff mechanism that accounts for traffic management that compresses vehicles closer to one another with converging speed assignments and shrinking headways.

It is another object to provide against an archetype for when vehicles will be their closest and analyze for the shutdown substantially before vehicles are traffic managed, or more particularly consolidated or compressed.

It is another object to provide an adaptively adjusting safety parameter set that changes along with a sensory based adaptive or robotic traffic management system where if traffic management system changes, the archetype of the safety shutoff changes along with it.

Further it is an object to provide for partial, feed-in, differential features of safety shut-off as they apply to partial, feed-in, differential features of the hosting traffic management system.

It is another object to provide for co-adaptively shutting down output, for instance influencing or inducing longer headways into the go-no go consideration for fog, ice, rain and the like.

It is another object to provide for multipurposefully shutting down output for a number of different reasons in addition to a headway induced go/no co consideration where in addition to a no go situation suspending readouts, there could be manual shut off, school bus, emergency vehicle preemption or the like that also independently suspends output.

More objects will be evident upon further examination into this disclosure.

### DESCRIPTION OF THE INVENTION

In case of a properly functioning traffic management system, for example either a FLOW (“Fast Lane On Warning”) emplacement or mobile readout, and whether autonomous or sensory based adaptable, there is a necessity that vehicles receive readouts that converge towards one another and that traffic as a whole be consolidated. More particularly, traffic would be compressed with reducing headway per vehicle. For the case of getting all traffic through during green phase, when traffic is compressed, it has spacing, both in distance and in time, from where it was throughout the whole repeating service cycle, Pi to that space and time of a net green, Tng. In other words, the compression would be the proportion of Pi, the whole service cycle period of the traffic light divided by the net green period (the period during which all the traffic is supposed to pass through).

There would be a previously random string of traffic with a physical boundary length that is the product of the traffic light service cycle period and the speed limit. Any number or combination of sensors located up the road from where traffic management occurs (or even where traffic management is beginning) would sense the traffic in the random stage. In further processing, the traffic would be counted, and analyzed per time for a realtime traffic density figure (i.e. passing vehicles per time). While further traffic management is under way, that length would be compressed into an “aggregate” length relating to the net green period, Tng.

Safe following distances in that “aggregate” length would be the closest in any of traffic managing compression and should not be closer than is normally safe. To establish this safety in a traffic managing situation, individual vehicles approaching the traffic managing zone, trap (or where compression begins), first need to be counted per time to establish a maximum pre-converging or pre compressed density. The processing would cross check with the ratio of Pi to Tng to know how big the time duration is. If the net places or “slots” in the traffic management pattern were too great to allow for a standard safety following time for each slot, there would be a Boolean “Go/no-go” function that kicks in and suspends the readouts until the density is safe enough again. In other words, the net green period, Tng is substantially a set distance and a set time; If the total places or “slots” (vehicles including their headway/following distances) exceed what it would allow for each place to have its own net safe following distance, headway or reaction time, than it would be too unsafe to allow for continued traffic management: especially if traffic is converging together.

The relationship is

$${P}_{safe following \geq \frac{{P}_{i}}{{t}_{ng}} ( SF )}$$

where:

P(safe following)=pre compression time limit (i.e. Boolean threshold)
Pi=service cycle period
Tng=period of “net” green where all compressed traffic goes through
SF=a standard safety following period, “headway” or “reaction time”, or “relative distance” in between moving traffic, that is the closest that relative vehicle following distances (space times) should ever be to one another. It is interpreted by starting a time as a lead vehicle passes a static reference point, than stopping the accumulated time as the following vehicle passes it. The accumulated time (“i.e. One-one-thousand, Two-one-thousand”) is the following period SF.

An “aggregate” length is a length that varies, but near the end of consolidation, compression, it is approximately the length of Tng as it is going through the signal. There is a non-definite aspect about it since the traffic is still being compressed at a tail end of a “fast Lane On Warning” (FLOW) pattern (or “platoon” as it is called in other references) while a beginning part of a FLOW pattern will be passing through the signal and thus be finished with compression and may be spreading out again to a degree. In other words, different parts of a FLOW pattern will be in different states, i.e. compressive, pre-traffic managed, and/or finished, at the same time.

A differential measurement of d(count)/dt may make that measurement more definite. This way of measuring density can account for a “feed in factor”. If d(count)/dt provides for too dense of traffic by the time it reaches net compression, it would signal for a no-go condition during that period. If d(count)/dt provided for traffic that were lean enough for traffic to still be compressed and with each vehicle in Tng still having its own safe following distance or reaction time, there could still b a “go” condition that allows for traffic management. With differential consideration, there is the possibility that parts of a FLOW pattern can be given valid assignments and still have safe following/headway whereas with the complete (non partial; non fragment) count type, there must be a completely sparse enough count throughout the whole Pi for it to work properly. Further for this data to be adequately sensed, there would need to be sensing further up the run up.

With the use of differential methodology, there could be more mobility, lesser expense, and more continuity.

A feed in or differential could reinforce the continuity of a traffic management system particularly when part of a traffic management pattern was lean enough but the other part got too dense. At one end of the adjustment for partial density would be continuity, more mobility, or green time per moving traffic, and at the other would be extra safety. That extra safety could include not restarting traffic management until one or more Pi time periods passed. An important example of where continuity would also determine safety is where the first half of a traffic management pattern or a consolidating FLOW (Fast Lane On Warning) pattern would be normally operating and then the rear half would be measured as too dense. The pattern would become unsafe if the shut-off had to wait till the Pi was finished, so that would be where a partial would encourage continuity. Also, more sensors placed further up the run up that could monitor multiple upcoming Pi random groupings could solve the same problem; If a large enough number were far enough up the run-up, the whole Pi could be shut off.

While the shut-off could be automatic, given the Boolean go/no go condition, there could be other types of methodologies that actuate a shut-down of the traffic management system. Examples of manual shutoff or intervention could include but are not restricted to: manual shut-down, prompting, preempting, prompting or preempting from aboard emergency vehicles, prompting or preempting from remote locations (i.e. control consoles). Automatic input examples could include: time of day shutoff, bad conditions shutoff, scheduled shutoff, emergency vehicle shutoff, automatic proximity, i.e. lights, sound, emergency automatic on-board rf (radio frequency), school bus proximity shutoff, prompting, preempting, delay shutoff. Bad conditions shutoff, could include manual as well as automatic sensing. For the delay shutoff, the system could wait for periods ranging from partial Pi through multiple Pi before turning back on. Partial or full control could be applicable to either manual and/or automatic inputs.

Once the traffic management system were shut down, the prompts or readouts could still be made to send messages depending on what kind of traffic management system were in place. If the system had graphical readouts, there could be an art file that might read “Drive Safely”; if the readout were an alphanumeric, it might be able to read out as FP meaning “Full Pattern”. Non numeric or non script graphics could also easily indicate a “no-go” if the system used such semaphores. If the readout is on-board, there could be audio messages that could suggest the “no-go” condition.

Adaptable traffic management systems would include those that can adjust according to what is sensed in the varying run-ups. Two main kinds of adaptability include changing Tng while Pi stays the same, and changing Tng while Pi also changes. Examples of traffic management in the former include tradeoff where an East West run-up(s) might be sensed as empty of traffic and a North South run-up(s) might be sensed as full. To better provide for mobility the Tng in E-W might shrink while the Tng in N-S might expand. For this condition, the shut-off system would have to expand and shrink as well along with the proportional expansion and shrinking of the specific run ups. Another of the many examples of Tng changing while Pi stays the same would include accommodation of wayward traffic from “voids” or empty places of compression. Space would have to be made for this wayward traffic with Tng redistributing or changing in size (i.e. length, time duration).

For the example of Pi changing along with Tng there could be a condition where the whole traffic management system shrinks or expands. If conditions were determined to be in need of more safety, the whole traffic management system could output slower readouts and concurrently expand the run-up lengths. Slowing down the system this way would doubly spread out the following distances and reaction times (i.e. with more time AND more distance both contributing to more reaction time and relative space). As with the first condition, there a multitude of differing possibilities that could see Pi and Tng change together.

When the changing and adaptability are part of the traffic management system, the conditional Go/No-go shutoff must expand or shrink the conditions along with Tng; if Tng shrinks. The number of slots or places and length of the condition must shrink. The same goes for expansion.

For a tradeoff condition, proportional like changing condition or the like, Tng would be the closest that vehicles in a compressed converging traffic pattern will be with one another. If Tng changes, there would be a buffer that is expanding or shrinking at any time during the process. Once that buffer was filled with a whole place or slot, there would be an additional place added to Tng. There may have to be an extra buffer to maintain continuity of the system (to prevent the system from jumping back and fourth too rapidly).

The conditional for the function of the shut-off Boolean Go/No-go would have to act in the same way where the place, slot would be added to the conditional the same as it was for Tng. The place or slot would include for each vehicle in a pattern the vehicle itself and an appropriate following distance confidence factor and so on. Each Tng would include a fixed number of places or slots and include a varying buffer. If that buffer became big (small) enough in a stable condition, i.e. the traffic managing were still continuous, another place would be added (subtracted) to the Tng.

Those familiar in the art would know that systems like the safety mechanism disclosed here could often function in increments; i.e. electronic scans. These increments could go every once in awhile with a scan representing a single analysis or the increments could happen many times a second, or possible many hundreds or many thousands of times per second. Under the latter condition, a multitude of scans could push the increment, place, “slot” or the like in one or the other direction. Once a sum has been reached, the extra “slot” could be added or subtracted thus dictating the number of places or “slots” there would be in a safety conditional as well as the Tng conditional.

A safety mechanism could be installed as integrated in with the traffic management system or could just as easily added on as a parasite or piggy backed fashion.

### DESCRIPTION OF THE DRAWINGS

Moving on now to the drawings,

FIG. 1 shows a schematic of the shutoff system as part of a traffic management system that tells traffic how fast to go in order to get through the signal while it is in green phase.

FIG. 2 shows prior art of the traffic management system, particularly the random pattern as it approaches vs. the net compressed pattern with the net green phase containing the compressed pattern of traffic and how consolidation/compression takes place.

FIG. 3 shows prior art of the traffic management system with shrinking headways, particularly a distance (as well as time) vs relative distance (as well as time) in the pattern as it is being traffic managed or compressed.

FIG. 4 shows essentially the same type of chart as FIG. 3 and including where speed assignments are too close for a post-compressed net safe following distance (reaction time) as well as where speed assignments are lean enough or sparse enough for a post-compressed net safe following distance (reaction time) that can allow for continued traffic management.

FIG. 5 shows a breakdown of the process in schematic as well as flowchart form including archetype, expansion, places and conditions for a go as well as no go.

FIG. 6 shows a Boolean summation and high frequency scan “drift” as it forms the addition (or subtraction) of a “place” or combination of vehicle and its following distance (reaction time).

FIG. 7 shows a container and sand analogy of how high frequency scans and drift contribute to adding or subtracting a complete place.

FIG. 8 shows a more ideal flowchart of a go/no go condition including default for the no go option.

FIG. 9 shows a partial or differentiated schematic presented in a streaming or ongoing continuum including switching back and fourth into and out of go/no go condition.

FIG. 10 includes a detail of the traffic management readouts or output data with the conditional being controlled by the processor counter as well as other influences.

### A DESCRIPTION OF A PREFERRED EMBODIMENT

A system of one or more sensors 1 up a road from a traffic signal 2 senses individual vehicles 3 as they pass by. The nature of said sensor could include but not be restricted to: Pneumatic, mechanical, sonic, audio, light, light curtain, infrared, ultraviolet, electromagnetic, radio, RADAR, video, pixel variation rate analysis, other motion detecting means, and the like. Just as easily, sensor(s) could include combinations of these. Once precise sensing is being undertaken, a count of density is established where vehicles per time is ascertained by Processor 4. The density count of Processor 4 influences a conditional or Boolean switch 5 such that if the net count is lean enough for safety, switch remains closed; if the count is too dense, the switch is opened. Switch 5 could be integrated into the traffic management system, or just as easily be installed as a “piggyback” or “parasite”.

Switch 5 dictates a go/no go for a traffic management system that tells traffic how fast to go in order to get through green phase of traffic signal 2. In this example, a “Fast Lane On Warning” (FLOW) sequencer 6 works in concert with RGY sequencer/controller 7 which runs the signal 2. FLOW sequencer also sends out the readouts 8 through the go/no go influenced switch 5 to readout modem 9 which further sends readouts either to emplaced RSU (roadside unit) prompt by cable 10 or to mobile onboard prompt through wireless means 11 or both means as necessary. For the wireless on-board output, SPAT (Signal Phase and Timing) data can be the content of the mobile readout with the on-board receiver Calculator Readout (RCR) doing the processing that provides for mobile speed readouts. Switch 5 is shown working on readout path 8 but can work on any part of the traffic management system.

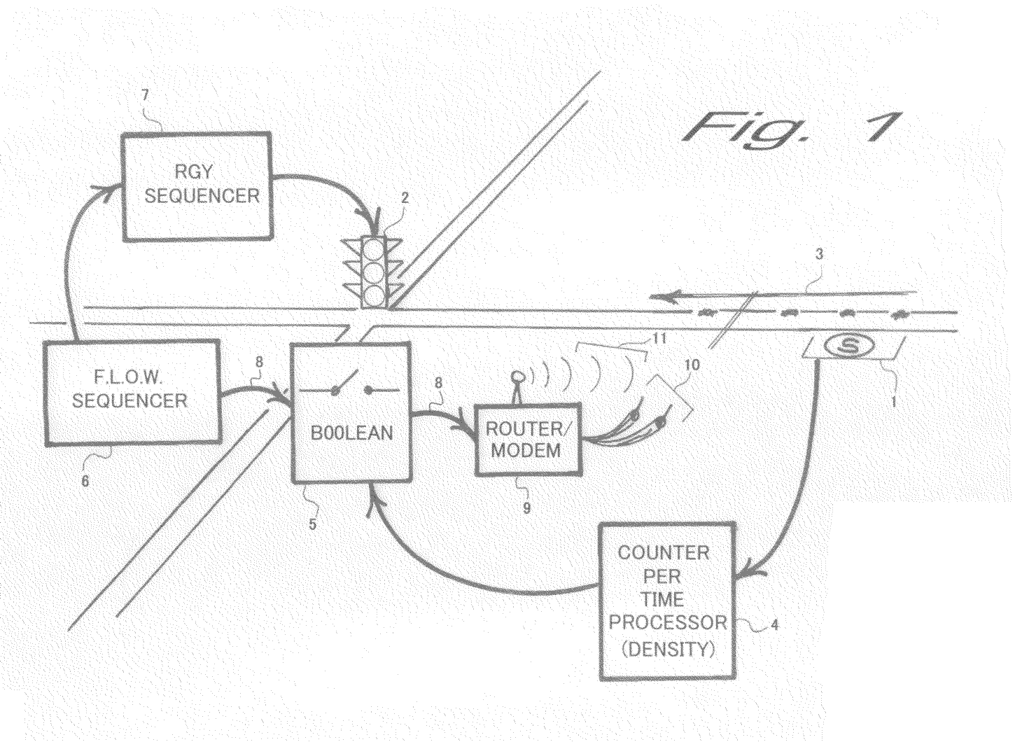

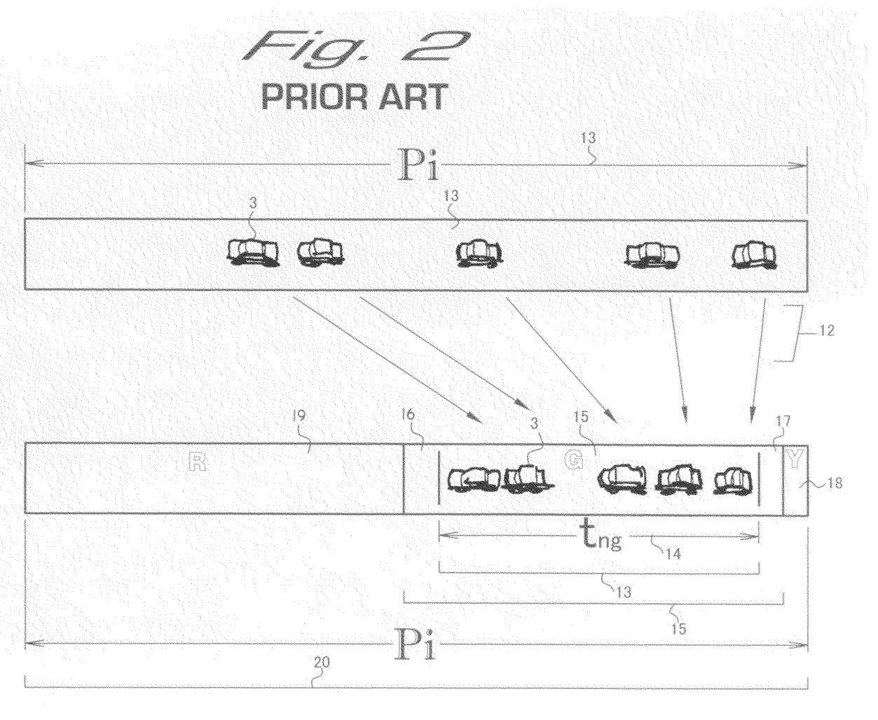

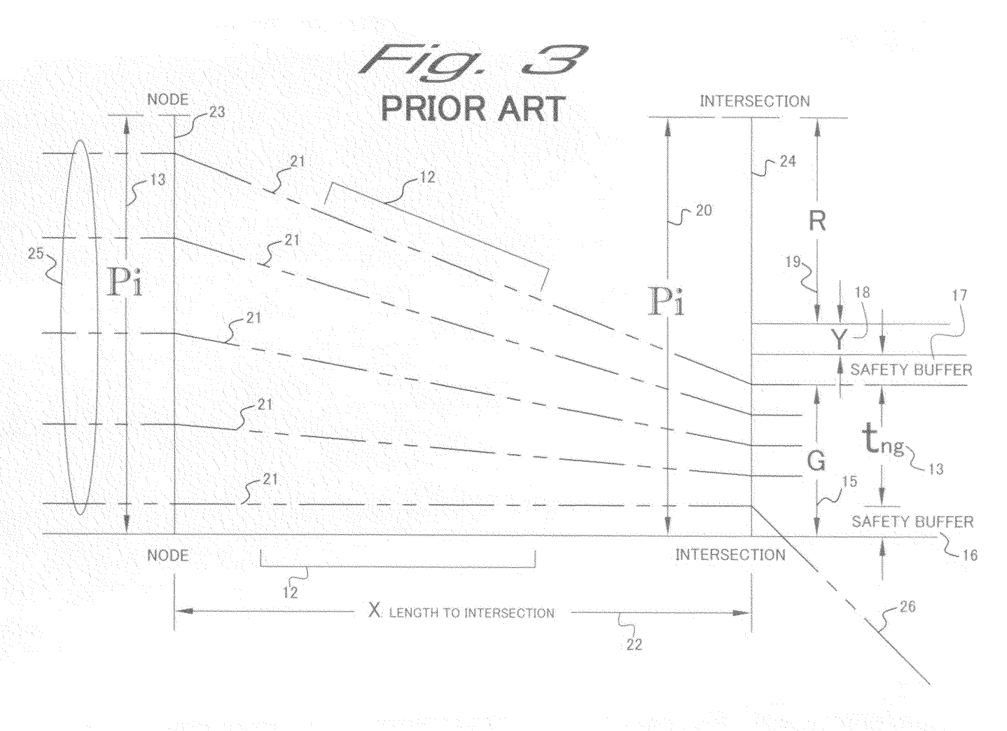

In getting traffic to go through during the green phase of signal 2, it must be consolidated or compressed 12 (in [FIG. 2] with individual speed assignments 8 converging on one another. Since these speed assignments converge, the vehicles get closer to one another, Before traffic management takes place, a random string of vehicles 3 (in [FIG. 1] are distributed throughout the service cycle Pi 13 in [FIG. 2]. As the compression, consolidation, converging speed assignments 12 take place, the traffic pattern eventually ends up in a smaller length as well as time period of “net” green Tng 14. Part of a bigger total green phase 15, Tng 14 is bracketed on forward and rear ends by pre-green safety and safe following buffers pgS and Tsf respectively, 16,17. Green phase 15 is joined with Yellow phase 18 Red phase 19 to add up to larger Pi at full or net compression 20.

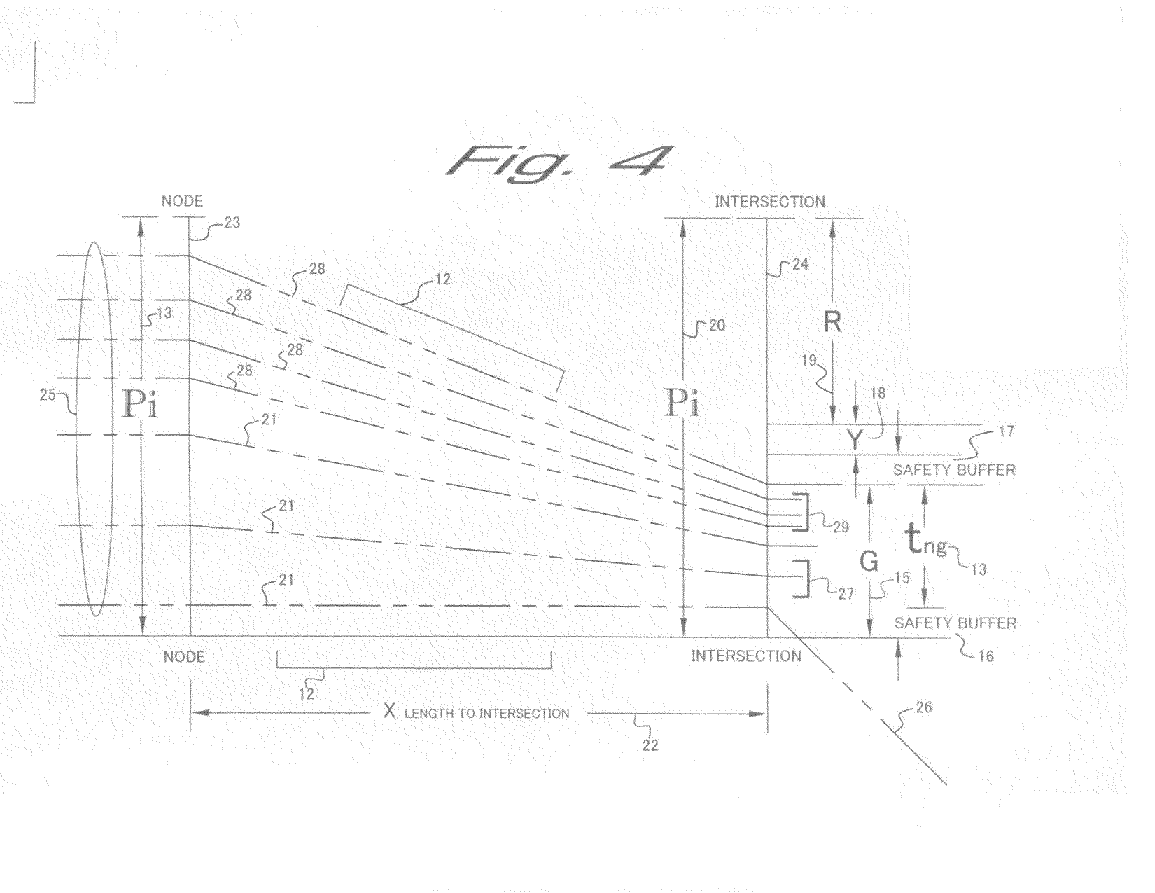

In [FIG. 3] individual converging assignments 21 are shown in a distance vs. relative distance chart (that could just as easily be time vs. relative time). Distance-to-intersection 22 from “node”23 where compression begins (whether node is “point threshold” or “range threshold”) to intersection 24 is compared to relative distance between vehicles due to their individual assignments 21. Vehicles starting out 25 in random pattern Pi 13 before being traffic managed or compressed 12. They become substantially the closest in traffic management that they would reach while at “full or “net” compression substantially near intersection 24. After proceeding through intersection (while signal is green), traffic could diverge and spread out again 26.

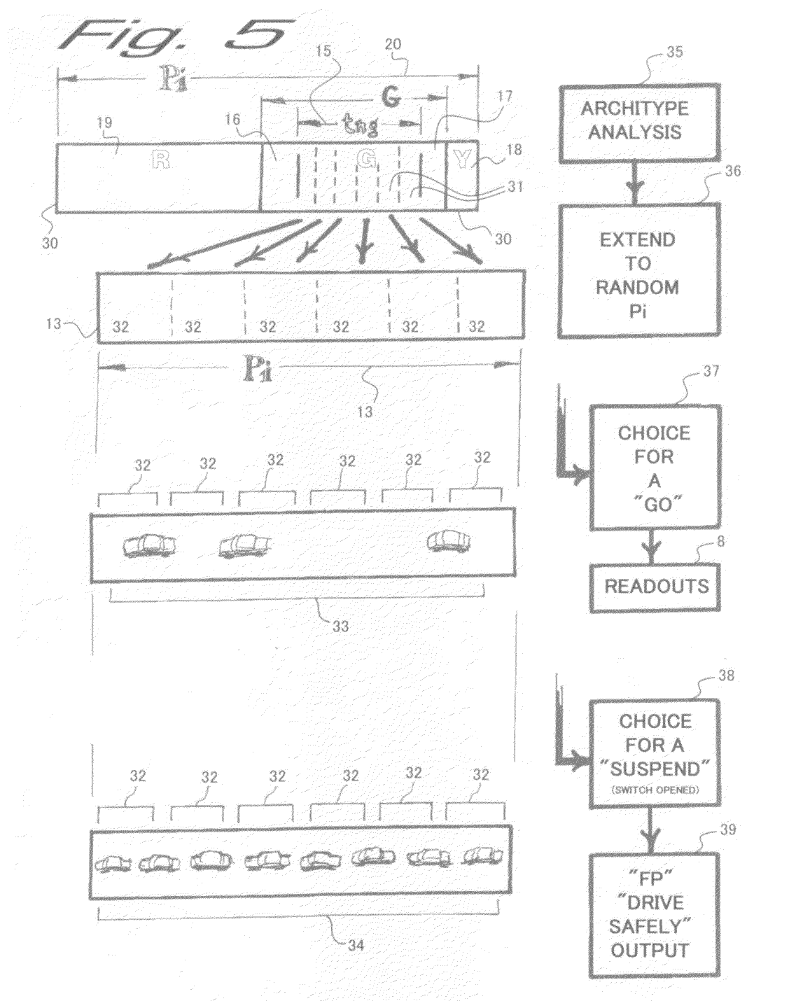

In [FIG. 4] part of individual converging assignments 21 yield net compressed or fully compressed closeness that can still allow for safe following distances/headway/reaction time 27. Close individual assignments 28 cause traffic to exceed the safety limit that results in net headway too close for safety reaction time/following distance 29 while converging at the net compression 24.

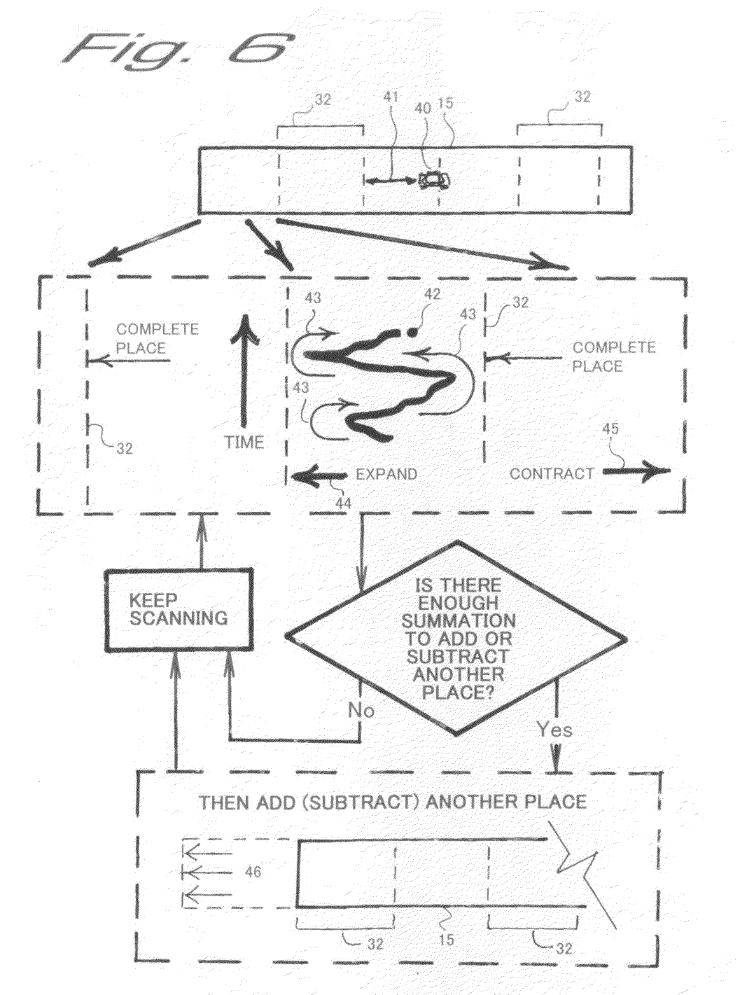

To get the right point of where go/no go occurs, first, an archetype 30 of how many safe followers per Tng 15 must be considered. The archetype 30 would be intended for the Pi at the point where net compression was the closest 20. Each fully or net-compressed place 31 in the Tng of the archetype would include a minimum following headway, space time or reaction time and would be expanded out to the Pi 13 in random traffic before traffic management occurs. The number of places 31 in the Tng 15 of the archetype 30 would be the same number of places 32 in the pre-compression Pi 13, although those in the random Pi 13 would be proportionally expanded. Projecting down (in [FIG. 5]), a random traffic pattern is lean enough so that each vehicle in lean pattern 33 has room enough or more to be in its own place 32. A further projected down denser pattern 34 has too many vehicles to distribute for each a complete place 32 including vehicle and its following distance/reaction time/headway. In the matching flowchart on the right side, the archetype analysis 35 is extended for the random Pi 36. The lean or sparse pattern 33 provides for a “go” condition 37, and the switch 5 (in [FIG. 1]) stays dosed and readouts 8 continue. Dense pattern 34 has too many vehicles per time to be able to include each vehicle and its following distance/reaction time/headway in the places 32 given in an eventual Tng 15. This produces an unsafe situation where vehicles are too close and therefore the system would be in suspend mode 38, and the switch 5 is opened and the readouts 8 are substituted for an appropriate default message of “FP” (for full pattern), “drive safely”, a “shut-down” type of graphic or the like 39.

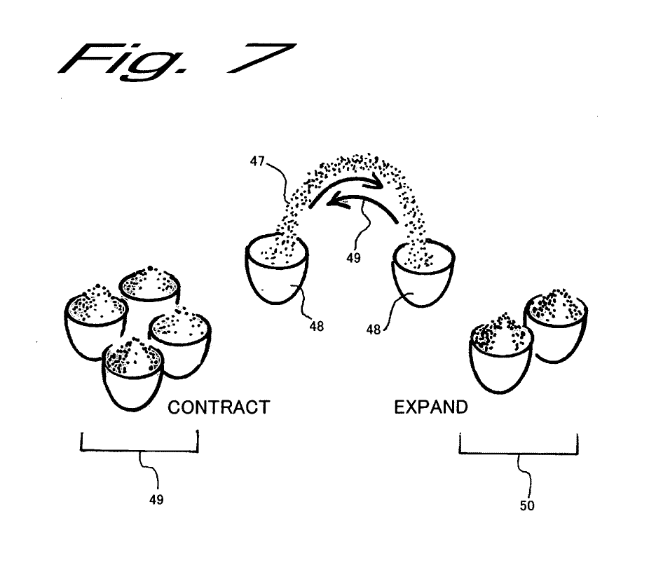

For an adaptable system, the number of places in an archetype 30 (in [FIG. 5]) will change along with the changing Tng 15. As the number of places in an adaptable Tng expands, so must the safety shutoff archetype place number expand. The same would go for a contracting: both Tng and the safety shutoff place archetype must contract together. While there can be many models that could apply to this embodiment, the addressing of scan frequency includes two following schools of thought: infrequent scans and frequent scans. Infrequent scans could produce place numbers for traffic managing and safety shutoff far apart, like every couple of seconds or so. High frequency scans can happen many hundreds or thousands of times per second. Such high frequency can be summated for expanding or contracting places. In [FIG. 6], an individual vehicle 40 has a following distance/reaction time/headway 41. Each Tng 15 has a set number of these combinations that show as a whole number of places 32. For a summated Boolean, many scans happen per second. Each scan, represented by a point 42 asks a question “Expand or contract?”. As these scans accumulate in one direction or the other, there becomes a “drift” 43 towards expanding 44 or contracting 45 direction. The drift 43 can go either way and as soon as the sum of the drift is far enough (and with the necessary extra compensating buffering so that the system remains continuous), a complete place 32, which includes vehicle 40 and following distance/reaction time/headway 41, is added 46 (or subtracted) to Tng 15.

The safety shutoff archetype expansion and contraction parallels that of the adaptive traffic managing system which is similar to the traffic management system expressed in [FIG. 2,3] but that changes based on sensory input. Reasons for expanding and contracting Tng include directional compensation for empty and full patterns (i.e. North-South full/expands; East-West empty/contracts) absorption of wayward traffic from “empty spaces” or “voids”, and increasing/decreasing overall Pi.

Any incomplete summation before a commitment is made for a full place 46 (expanded or contracted) can be absorbed by safety buffer time/space 16, 17 (in [FIGS. 2,3,4,5]).

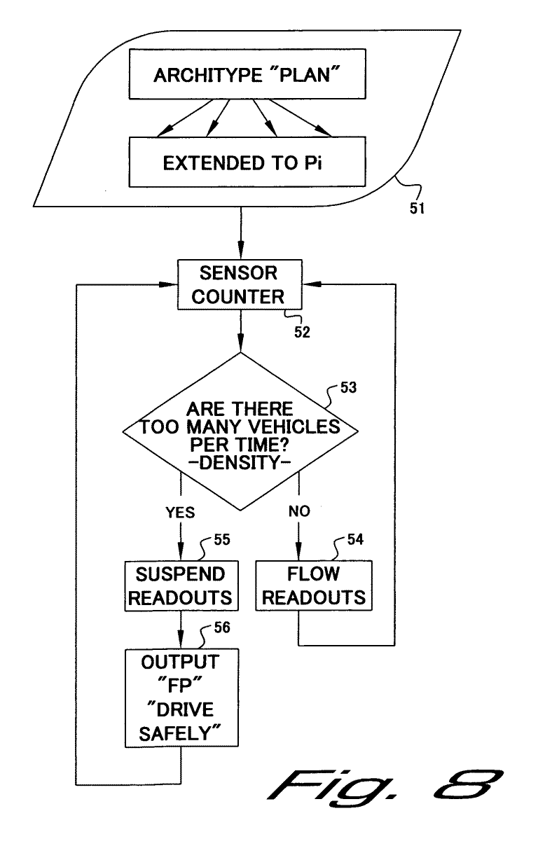

Another analogy for summation can be found in [FIG. 7]. If each high frequency scan were a grain of sand 47, and each place were a container 48, the scans would cause the sand to drift back and fourth between filling-emptying, and emptying-filling 49. If a complete container were filled, another place would be added. There would be a whole-number amount of places in a Tng and containers would shift between contracting 49 and expanding 50.

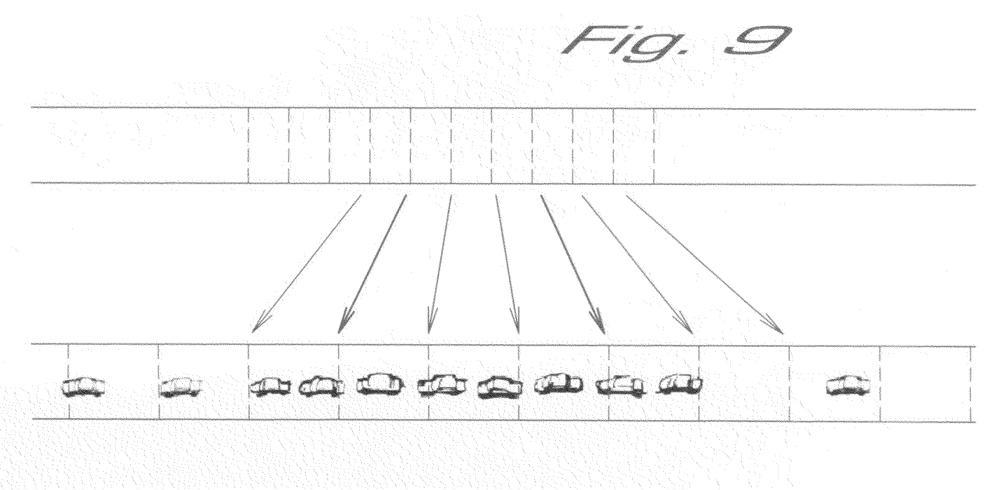

In a pure Flowchart sense, the archetype (in [FIG. 8]) is either embedded or becomes re-embedded (i.e. updated) with sensory or adaptive traffic management systems 51 and includes means of expanding to Pi. With that data, a sensory based counter 52 has something to compare to. Upon answering the question of whether there are to many or not (too dense or not) 53, two choices emerge. If traffic is still lean enough, traffic management/FLOW readouts can be allowed to continue 54. If there are too many vehicles per time, the choice would be to suspend readouts 55, and refer to default outputs such as “FP” or “Drive Safely” or the like 56.

For feeding condition and fragmented go/no go in the same Pi, there must be the consideration of partial Pi and/or differential feed. For a Pi that starts out to be lean enough for traffic management but becomes too dense, it would be dangerous to wait for the Pi cycle to finish before shutting off the traffic management. Therefore it would be necessary in this and other cases to be able to shut down on a partial basis with respect to Pi. In [FIG. 4], traffic that is lean enough to be assigned to a Tng along with its respective following distance (s)/reaction time (s)/headway (s) 27 can allow for continued readouts 8 (in [FIG. 1]). Meanwhile, if readouts were to become too dense in the same Pi 28 (in [FIG. 4]), they would cause following distances to become too close near net compression 24, so that there would be too many vehicles per time there 29 to be safe.

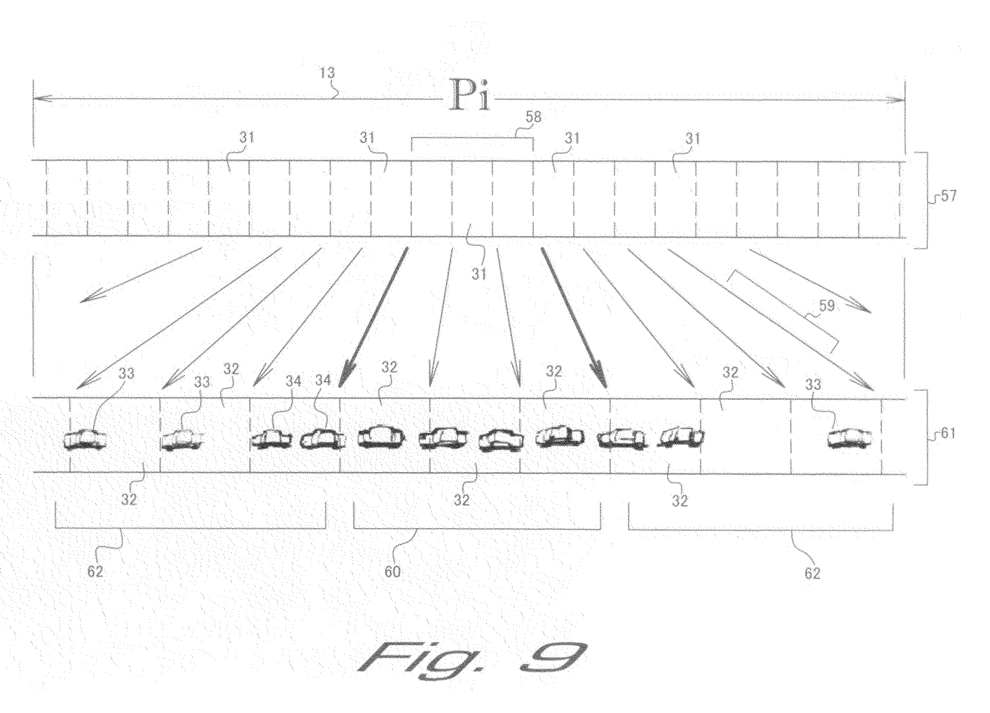

In [FIG. 9] a differentiated consideration is charted on a moving or “streaming” archetype 57. The archetype 57 includes a sample 58 which is expanded 59 for full places in a pre-traffic management pattern sample 60. Go/no-go is established by whether traffic too dense or lean enough for traffic management on a differential, streaming, or ongoing basis. Traffic is shown to be too dense in sample 60 embedded in Streaming Proportional Expanded Pre Traffic-Management Continuum 61. In sample 60, since there are more vehicles 34 than places 32, a “no-go” condition 38 (in [FIG. 5[) would be in effect. Therefore, readouts 8 (in [FIG. 1]) would be suspended. Traffic is shown to be lean enough 62 both before and after “too dense” sample 60. “Lean-enough” sample 62 would provide for a go condition 37 (in [FIG. 5]), since there are as many or more places 32 than “lean traffic” vehicles 33, which would allow for readouts 8 (in [FIG. 1]) to continue. Both Archetype and Resultant Net Proportionally Expanded Pre Traffic-Management Continuums 57 and 61 respectively are projected against Pi dimension 13 to show how go condition 37 (in [FIG. 5]) and no-go condition 38 (in [FIG. 5]) can multiply fit into a Pi 13.

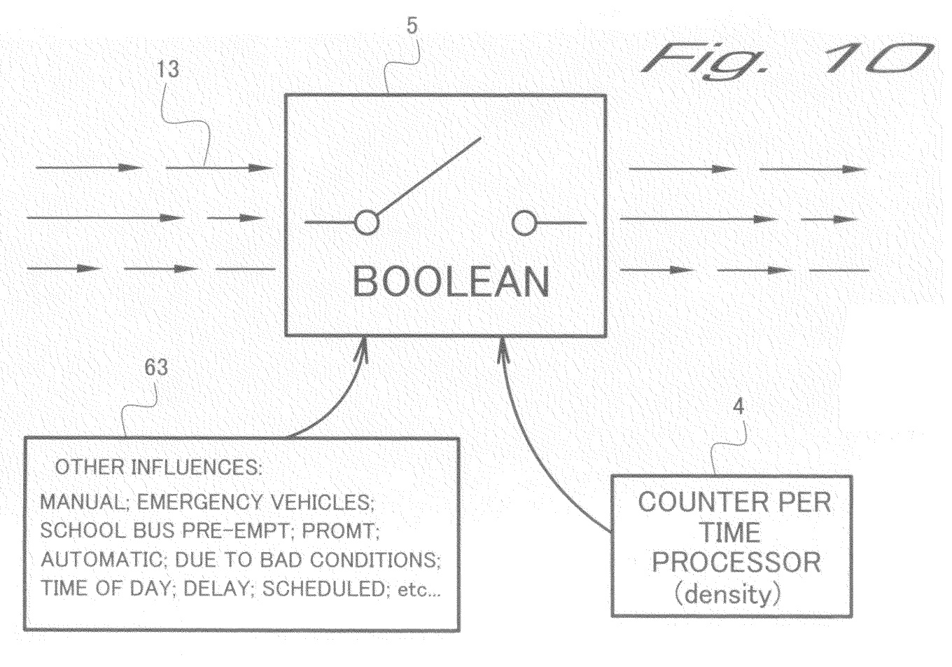

Outside influences can be integrated into the Go/no go system. While the Boolean switch 5 in [FIG. 10] is autonomously dictated by counter per time (density) processor 4, that same switch 5 can be actuated by intervention 63 whose articulation could be caused by other automatic or manual means including but not restricted to the following examples: For manual, switching from control console,

prompting,
preempting,
prompting or preempting from aboard emergency vehicles,

For automatic, examples could include:

time of day shutoff,
bad conditions (i.e. ice fog, rain . . . ) shutoff,
scheduled shutoff,
emergency vehicle shutoff,
automatic proximity, i.e. lights, sound,
emergency automatic on-board rf (radio frequency),
school bus proximity shutoff,
delay shutoff.

Bad conditions shutoff, could include automatic sensing. For the delay shutoff, the system could wait for periods ranging from partial Pi through multiple Pi before turning back on.

What is claimed is:

1. A safety shutoff device for a traffic management system that comprises of:
a counter that counts density of traffic flow including passing vehicles per time,
a processor that analyzes whether the count is lean/sparse enough, or too dense to allow traffic management system to function.

2. the device of claim 1 wherein traffic might converge/be brought closer together in time and space or with reducing individual vehicle headway due to management.

3. The device of claim 2 wherein processor might take into account the closeness in space and time, for example as a headway, following distance, reaction time, and analyze for the closest that said following distance might be,
and process and allow for that closeness when said traffic was far apart and including when said far apart traffic was a random pattern approaching said place where traffic management occurs.

4. A device of claim 3 that includes means of sensing vehicles approaching an area that is traffic managed,
Said device including means for detecting and counting individual vehicles per time in one or more lanes of a roadway in one or more directions, primarily where moving zones or patterns are ultimately to be filled with traffic, wherein heightened mobility is in use,
wherein said heightened mobility zones are associated with a traffic signal,
wherein said traffic management includes compressing, condensing, converging a previously random string of traffic into a net green pattern length and time period such that said pattern is intended to go through intersection of said traffic signal while said signal is open or green,
wherein said previously random strings of traffic are divided up in lengths and time periods of the service cycle of said traffic signal
wherein said traffic management system is conducive to counting individual vehicles per time and switching on or off, depending on whether net density is safe enough,
a means of ascertaining as to whether there are too many vehicles counted per time for said vehicles to have a net safe following distance as they are in their final run, or most dense part of run, while going through traffic management,
wherein there is a Boolean condition, or “go/no go” condition choice that dictates whether it is either safe, or not safe for traffic management,
wherein place or slot in said previous random pattern associated with following distance, space time, reaction time at beginning of where traffic is managed is determined by the product of a standardized safety following factor and the ratio of the service cycle of the intersection and the net green,
wherein said net green is space time that total service cycle Pi space time in previous before-management random string was compressed, converged, or condensed to,
and wherein the density of said space time during net green Tng is either too dense or lean enough to still maintain vehicles, all with adequate headway, reaction time, relative safe following distance,
wherein said standardized headway/safety following factor is a standardized safe following space time wherein said space time can be taken as the time that accumulates between the instant when a leading vehicle passes a relative static reference point by roadside, and the instant a following vehicle passes the same reference point, wherein that time can also be interpreted as a relative distance between the two moving vehicles,
wherein service cycle is a repeating cycle of signaled intersection,
wherein the net green is the time intended for the managed traffic to go through while signal is open, and containing the necessary buffers, secondary buffers that may add to said net green wherein said buffers would account for late arrivals, early arrivals, wayward traffic, absorption of specially assigned vehicles . . . ,
wherein there may be more mobility involved as a result of traffic management, but more importantly, more safety in prevention of traffic management causing too dense of traffic to result because of too close of headways or following distances or reaction times.

5. The device of claim 4 wherein the equation that describes the safe following headway in terms of time is:
$${P}_{safe following \geq \frac{{P}_{i}}{{t}_{ng}} ( SF )}$$
Wherein Pi is service cycle period of intersection,
SF, ‘Safe follow Factor’ is the minimum safest headway, reaction time; space time; following distance,
Tng is the “net” green part of green phase where the consolidated compressed traffic is intended to go through,
P safe following is the pre-processed bracket for eventual reaction time; space time following distance, taken at beginning of traffic management or before,
wherein there can be a certain number of Psafe following places or slots per Tng.

6. The system of claim 4 wherein safety limit is established at an initial contact headway “space-time” expansion wherein there is an expanded time measured, counted, processed such that after any consolidation, compression (per time), convergence, traffic management, that final safety following “space-time” or established headway would be no smaller than a net safety following “space-time” or established headway wherein said “space-time” or established headway will create what is equal to or greater than a commonly agreed upon setting of safe relative following distance/“space time” or established headway,
wherein said “lean enough traffic” is defined where a set number of places or slots, each where its space-time/headway is still ok for motorist to have an adequate reaction time.

7. The system of claim 4 wherein said process of analyzing whether or not traffic is too dense or lean enough works under a feeding in condition.

8. The device of claim 7 wherein open random traffic developing into “aggregate” time considerations and open random traffic developing into “aggregate” pattern-length considerations apply to moving developing patterns relative to a static access point, and to relative positions of moving vehicles; moving traffic,
Including the possibility of shutting traffic management systems/functions off or on, making decisions part-way into traffic management patterns or part way out of said patterns (including within patterns and multiple times),
wherein fragments of patterns could still be OK to turn on or off traffic management systems,
wherein portions of patterns, i.e. Pi and Tng can still remain operational,
wherein there can be more mobility,
wherein there can be allowance for continuity in traffic management,
and wherein too much traffic density in a phase fragment can be avoided as could happen if shut-off had to start early allowing for the rear portion of a phase to still be open and provide for more mobility,
and wherein the danger of too much traffic density in a phase fragment can be avoided as could happen if shut-off had to wait till end of phase providing for more safety.
wherein system processor can wait for partial Pi through multiple Pi before turning back on

9. The system of claim 7 wherein said analysis can be applied on a differential basis,
wherein said differential increments can range in the smaller magnitudes (higher frequency) from many thousands of increments per second, or many increments per second,
wherein other extreme of said range can include increments that are large enough to include combination of vehicle and following distance, headway, reaction time, space time, and confidence factor,
wherein said combination could be amount to a multiple number of whole seconds.

10. The system of claim 4 wherein said system can be installed in an integrated condition.

11. The system of claim 4 including option for manual, automatic inputs,
wherein said manual and/or automatic inputs can range from being partial or totally in control of said system,

12. The system of claim 4 wherein while the traffic management system is functioning, that readouts take place, and while system is in “shut down” or “no go” mode that an appropriate message corresponding to “shut down” or “no go” perceivable by motorist still remains.

13. The system of claim 10 wherein said message is appropriately integrated with readout methodology,
wherein said easily perceived offline output can include a “FP”-type readout (i.e. “Full Pattern”) for alphanumeric readouts; a “Drive Safely”-type sentence for message board type readouts; an appropriate graphical semaphore for non-sentence, non alphanumeric readouts.
wherein easily perceived output can include audio messages

14. The “go/no go system of “safe or not safe” in claim 4 wherein “go/no go” is established by whether a set number of places per net green Tng is exceeded or not,
wherein said set number can also include closest rounded off number of places wherein traffic management can happen,
wherein said place can be any combination of vehicle plus appropriate following distance, reaction time, space time, and confidence factor,
wherein said places are detected within a Pi where they are spread out substantially the most that they will be (i.e. in random approach substantially before detection/counting/traffic managing).

15. The system of claim 4 that acts with dynamically changing and/or adapting traffic management systems (i.e. sensor based) wherein said set number of places (in claim 14) can change along with the adaptability of the traffic management system.

16. The system of claim 15 wherein there is a shrinking and or expanding “net green” Tng, and therefore number of place changes
wherein said Pi is constant while said Tng changes.

17. The system of claim 15 wherein there is a shrinking or expanding Service Cycle Pi, and including number of place changes in an also-changing Tng.

18. The system of claim 15 where the safety shutoff adaptively changes in “jumps” or increments,
wherein there is a range between numerous (i.e. multiple seconds per time, or many times a second) calculations or analytical scans and a multitude (i.e. many or more thousands of times per second) of analytical scans,
wherein said scans individually determine whether the dynamic change is going in one direction or the other
wherein the frequency of scans could range between “independent analyses” and a constant “vision” of the direction the dynamic change is going in,
wherein the increments either add to/subtract from a buffer, or if past a certain limit/delineation, add or subtract a whole “place” (as from claims 14, 15),
and wherein if need be, said delineation would be required to surpass the necessary extra safety time buffers (to prevent loss of continuity by too rapidly changing back and fourth),
wherein the increasing or decreasing places can apply to expanding contracting Pi,
wherein the increasing or decreasing places can apply to expanding contracting Tng, including through unified phase increases or decreases, or opposing direction tradeoff increase/decreases.

19. The system of claim 10 wherein there is an option for parasitic installation i.e. wherein safety hardware can be mounted in with already existing hardware in a piggyback or parasite condition, and wherein safety hardware can be worked in with already existing infrastructure,

20. The system of claim 11 wherein said manual inputs can include for example, manual intervention, manual shut-down, prompting, preempting, prompting, preempting aboard emergency vehicles, prompting or preempting from remote locations (i.e. control consoles),
wherein examples of automatic inputs include, time of day shutoff, bad conditions shutoff, scheduled shutoff, emergency vehicle shutoff, automatic proximity, i.e. lights, sound, emergency automatic on-board rf/radio frequency, school bus proximity shutoff, prompting, preempting, delay shutoff,
wherein with said delay shutoff, system can wait for periods ranging from partial Pi through multiple Pi before turning back on,
wherein said manual and automatic inputs can make system perform more safely.
